(19) United States
(12) Patent Application Publication
(10) Pub. No.: US 2016/0185286 A1
(43) Pub. Date: Jun. 30, 2016

(54) LIGHT ASSEMBLY COMPRISING AN OPTICAL DEVICE INTEGRATED INTO A MOTOR VEHICLE AIR-CONDITIONING ASSEMBLY

(71) Applicant: Valeo Vision, Bobigny Cedex (FR)

(72) Inventors: Philippe Cazenave, Villeneuve D'ascq (FR); Remi Letoumelin, Chessy (FR); Nicolas Boiroux, Pontoise (FR)

(73) Assignee: Valeo Vision, Bobigny Cedex (FR)

(21) Appl. No.: 14/911,598

(22) PCT Filed: Sep. 4, 2014
(86) PCT No.: PCT/EP2014/068813

§ 371 Date: Feb. 11, 2016

(30) Foreign Application Priority Data
Sep. 5, 2013 (FR) 1358482

(51) Int. Cl. B60Q 3/00; F21V 33/00; B60Q 3/02

(52) U.S. Cl. CPC B60Q 3/002; B60Q 3/0203; B60Q 3/0243; F21V 33/0092; B60Q 2500/20; F21Y 2101/02

(57) ABSTRACT

A light assembly comprising an optical device adapted to be mounted onto an air-conditioning duct of a vehicle. This optical device comprises means for fastening it to the duct, and comprises an optical guide element adapted to receive through an input face the light rays emitted by at least one light source positioned outside the duct, and to diffuse said rays through an output face directed toward the inside of the duct.

Thus the optical device enables the elements of the air-conditioning duct to be interconnected, while carrying means for providing the internal illumination of this duct.

The invention also relates to a vehicle equipped with an air-conditioning assembly whose ducts are internally illuminated by the optical device of the light assembly, controlled by instructions from the control module of said air-conditioning assembly.

The present invention relates to the field of lighting and to the field of air conditioning; more particularly, it concerns a light assembly comprising an optical device integrated into a motor vehicle air-conditioning assembly.

At the present time, commercially available motor vehicles are usually equipped with an air-conditioning assembly, enabling the user to create an inflow of cold or warm air, depending on the temperature that he wishes to establish and the existing temperature of the passenger compartment.

Conventionally, the air-conditioning assembly records the user's request and compares it with a temperature measurement, in order to determine a temperature differential and adapt an instruction for controlling the air distribution accordingly. If the pressure differential is positive, that is to say if the user wishes to establish a temperature above the temperature of the passenger compartment, warm air is sent into the air-conditioning ducts to supply the passenger compartment via one or other of the air outlet nozzles distributed in the vehicle. Conversely, if the pressure differential is negative, that is to say if the user wishes to establish a temperature below the temperature of the passenger compartment, cold air is sent into the air-conditioning ducts.

Finally, attempts have been made to provide supplementary visual information to the user, in order to improve his awareness of the correct operation of the air conditioning. On the same date as the present filing, the applicant has filed a patent application describing a procedure for diffusing light rays simultaneously with the switching on of the air conditioning, these light rays producing a certain color, the choice of which depends on the operating conditions of the air-conditioning assembly.

The present invention lies within this context and is intended to provide a light assembly which is inexpensive, while also being easy to use and easy to integrate into the air-conditioning assembly.

For this purpose, the invention proposes a light assembly comprising an optical device adapted to be mounted on the path of an air-conditioning duct of a motor vehicle, said optical device comprising first and second fastening means at one and the other of its axial ends respectively, for fastening said device to an air inlet pipe and to a connecting tube fixed to an air outlet nozzle. The optical device further comprises an optical element. This optical element is adapted to receive through an input face the light rays emitted by at least one light source, notably a source positioned outside the air-conditioning duct, and to diffuse said light rays through an output face directed toward the inside of said air-conditioning duct.

If desired, the optical element may be an optical guide element. If desired, the optical guide element may be of annular shape and may have an axis of revolution coinciding with that of the air-conditioning duct at the mounting location of said device. The expression “annular shape” denotes a shape which is either partially or completely annular. In this case, the light rays are guided in the optical guide element from this input face to the output face by successive total internal reflections.

In a variant, the optical element may be a dioptric element, having a reflection face between the input face and the output face, arranged to reflect by total internal reflection the light rays passing from the input face toward the output face. If necessary, the optical element may be of annular shape and may have an axis of revolution coinciding with that of the air-conditioning duct at the mounting location of said device.

Evidently, the first and second fastening means are arranged on the path of the air-conditioning duct so as to enable all the air to flow, notably in a sealed manner, from the air inlet pipe to the connecting tube.

Thus a single optical device is used to provide a double function of internal lighting of an air-conditioning duct and interconnection of the elements of this duct, thereby integrating the functions and allowing precise and easily accomplished positioning of the light sources required for the function of internal lighting of the air-conditioning ducts, which is desirable in order to provide the user with visual information to supplement the awareness that he may conventionally have of the correct operation of his air conditioning system.

According to some characteristics of the invention, the input face is housed outside the air-conditioning duct defined by the air inlet pipe and the connecting tube, being notably substantially perpendicular to said axis of revolution, and the output face is inclined relative to the plane of the input face and is directed toward the inside of said air-conditioning duct. This arrangement enables the air-conditioning ducts to be internally illuminated without the need to integrate the whole of the light assembly into the duct for this purpose, which would create difficulties in its fitting and in its connection to the control module of the air-conditioning assembly.

According to a particular arrangement of the invention, the output face is oriented in such a way that the rays adapted to pass through it by refraction are guided toward the inside of the air-conditioning duct, and mainly toward the inside of the connecting tube.

According to a different arrangement, the output face is oriented in such a way that the rays adapted to pass through it by refraction are guided toward the inside of the air-conditioning duct, and mainly toward the inside of the air inlet pipe. In this way, indirect lighting is provided.

In these two arrangements, the angle of orientation of the output face depends on the geometry of the air-conditioning duct, and in particular on the length of this duct. The output face, of annular shape, may have a mean diameter which is greater or smaller than the inside diameter of the connecting tube. Evidently, if the output face has a greater mean diameter, this face is retracted.

According to one or other of these arrangements, the optical device is fitted in such a way that the first fastening means interact with the connecting tube or the air inlet pipe respectively, while the second fastening means interact with the air inlet pipe or the connecting tube respectively.

The optical element carries the first fastening means. It may also carry the second fastening means.

According to a characteristic of the invention, the first fastening means take the form of a first simple annular wall adapted to be mounted by fitting around the upstream end of the connecting tube of the air outlet or around the downstream end of the air inlet pipe, said first wall being made in one piece with the optical element and prolonging the latter axially at its free end. In the case of an optical element of partially annular shape, the free end may be prolonged axially, this prolongation being itself prolonged radially around the axis of revolution of the duct so as to form the first annular wall. In the case of an optical element of completely annular shape, the free end is simply prolonged axially.

The second fastening means may themselves take the form of two annular lips adapted to grip the downstream end of the air inlet pipe or the upstream end of the connecting tube of the air outlet, one of the lips being formed by an annular body of the support element, while the other lip is formed by a fin made in one piece with the body and extending axially along the latter.

According to one embodiment of the invention, the optical element carries the first fastening means and the second fastening means, the first fastening means taking the form, if appropriate, of a first simple annular wall adapted to be mounted by fitting around the upstream end of the connecting tube of the air outlet or around the downstream end of the air inlet pipe, said first wall being made in one piece with the optical element and prolonging the latter axially at its free end, the second fastening means taking the form of a second simple annular wall adapted so that the upstream end of the connecting tube of the air outlet or the downstream end of the air inlet pipe is mounted by fitting around said second wall, said second wall being made in one piece with the optical element and prolonging the latter axially at the level of the output face. In the case of an optical element of partially annular shape, the end of the optical element at the level of the output face may be prolonged axially, this prolongation being itself prolonged radially around the axis of revolution of the duct so as to form the first annular wall. In the case of an optical element of completely annular shape, this end is simply prolonged axially.

According to one characteristic of the invention, the light assembly comprises a support element associated with the optical element. The latter may be attached around the support element by gluing. In this case, the support element advantageously has a radially projecting ridge around the whole periphery of the annular wall of the support element, said ridge being adapted to receive means for the gluing of the optical guide element. Provision may also be made for the support element to carry the second fastening means, while the optical element carries the first fastening means.

According to other characteristics of the invention, each light source is formed by a light-emitting diode mounted on a printed circuit board which is of substantially annular shape and is fixed to an annular collar made in one piece with the support element, so as to be positioned facing the input face of the optical element. The diode may be an RGB diode.

According to a particular arrangement of the optical guide element, the latter comprises a receiving area, formed by a first annular portion with a straight cross section, and a distribution area, formed by a conical annular portion positioned in the prolongation of the receiving area. The receiving area comprises an outer face and an inner face which are parallel and define a guide path between a free end face and the distribution area, which also comprises an outer face and an inner face together with an end face, the outer face and the inner face of the distribution area prolonging the outer face and inner face of the receiving area with an angle of inclination such that the outer and inner faces of the distribution area extend in the direction of an approach toward the common axis of the air inlet pipe and the connecting tube. The end face of the receiving area corresponds to said input face, and the end face of the distribution area corresponds to said output face.

According to one characteristic of the invention, if the support element has a ridge as described above, it is the inner face of the distribution area that is applied to the ridge of the support element.

This output face may be striated. This promotes the scattering of the light rays diffused into the ventilation duct and helps to give the user an impression of a diffused light.

The optical element is made of PMMA, while the support element is made of polycarbonate (PC). The choice of material used for the optical element is based purely on optical considerations, whereas the material chosen for the support element is easier to work, so that the fastening means can be produced without difficulty.

The optical device may also comprise an enclosure forming a housing in which the light source and the optical element are protected. The enclosure has an axial wall extending axially at a distance from the optical element, and a transverse wall fitted around the connecting tube.

The invention also relates to a motor vehicle in which an air-conditioning assembly comprises a control module adapted to generate instructions for controlling the air distribution in air-conditioning ducts which are distributed in the structure of the vehicle and which have inlet pipes for guiding this air toward nozzles for the outlet of the air toward the passenger compartment. The vehicle according to the invention is specific in that it comprises at least one light assembly such as described above, in which an optical device is fitted in the prolongation of, on the one hand, a connecting tube fixed to an air outlet nozzle, and, on the other hand, an air inlet pipe, to provide an interconnection thereof and allow the continuous passage of the air toward the air outlet nozzles, and in which this same optical device is also adapted to illuminate the inside of the corresponding air-conditioning duct.

According to one characteristic of this vehicle according to the invention, the light source is a light-emitting diode mounted on a printed circuit board which comprises a microcontroller connected to the control module of the air-conditioning assembly, notably in order to receive instructions for switching on the light-emitting diode on the basis of data centralized by said control module.

Other characteristics and advantages of the invention will be evident from a reading of the following detailed description of an embodiment, the comprehension of which will be aided by reference to the appended drawings, in which:

FIG. 1 is a perspective view of a light assembly according to the invention, including an optical device mounted between a connecting tube of an air outlet nozzle and an air inlet pipe;

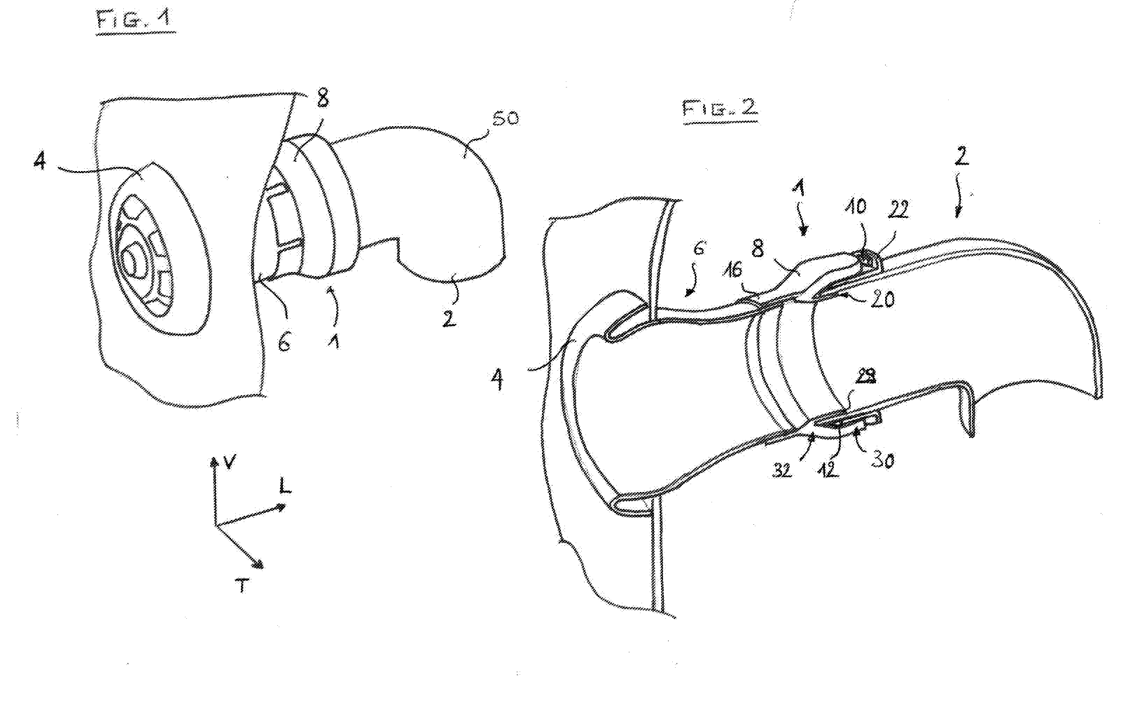

FIG. 2 is a view similar to that of FIG. 1, in cross section in a vertical longitudinal plane;

FIG. 3 is a side view, in section, of the light assembly of FIG. 1 according to a first embodiment, in which the optical device comprises an optical guidance element of which an output face is inclined toward the air outlet nozzle, and is slightly projecting toward the inside of the optical device;

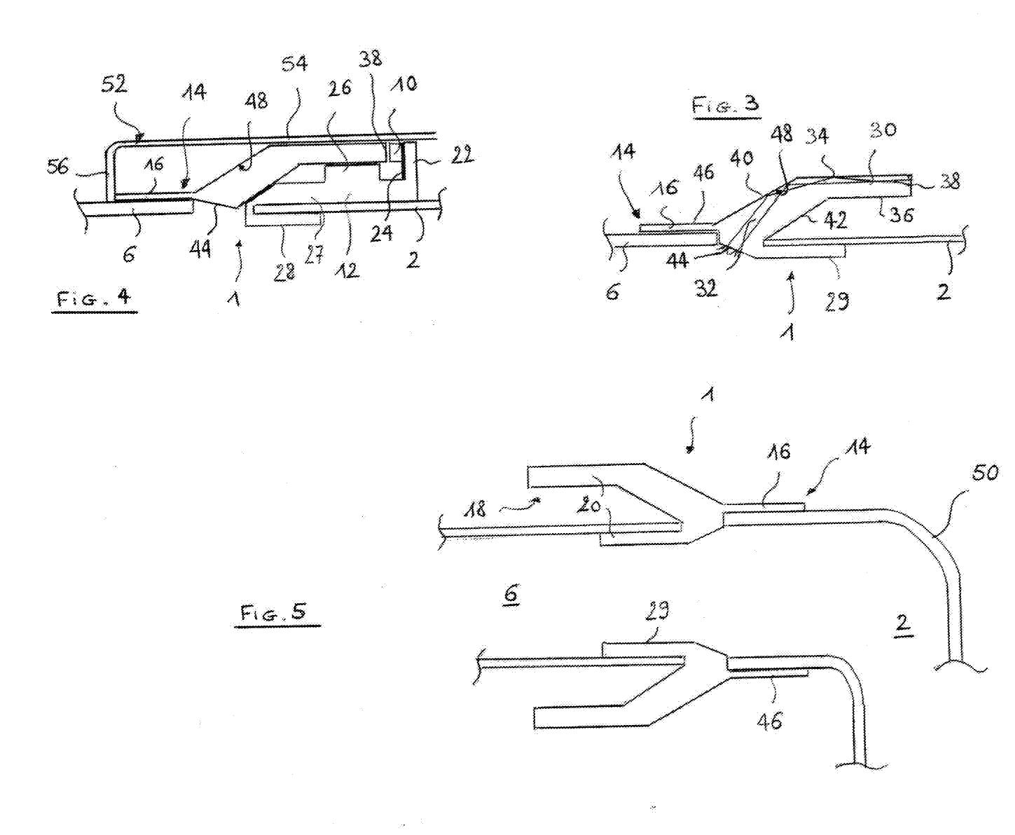

FIG. 4 is a side view, in section, of the light assembly of FIG. 1 according to a second embodiment, different from the embodiment of FIG. 3 in that the output face is arranged in a position retracted from the axis of the optical device; and

FIG. 5 is a side view, in section, of the light assembly of FIG. 1 according to a third embodiment, which is distinctive, notably, in that the optical device comprises an optical guidance element of which an output face is oriented toward the air inlet pipe, in the opposite direction from the air outlet nozzle.

In the following description, a longitudinal, vertical and transverse orientation according to the orientation conventionally used in the motor industry, indicated by the triple coordinate system L, V, T shown in FIG. 1, will be used in a non-limiting way.

As shown in the figures, a light assembly according to the invention mainly comprises an optical device 1 adapted to be positioned in an air-conditioning assembly of a motor vehicle, and notably on the path of an air-conditioning duct, being arranged between an air inlet pipe 2 and an air outlet nozzle in the passenger compartment of the vehicle 4.

The air-conditioning assembly comprises a control module, not shown, which calculates the air temperature to be provided in the passenger compartment, and comprises air-conditioning ducts which extend, notably, behind the instrument panel of the vehicle to guide the air toward outlet nozzles for diffusing the treated air into the passenger compartment.

In this case, the air outlet nozzles 4 are finned nozzles, but evidently they can have any shape on the fascia. These nozzles are prolonged toward the inside of the instrument panel by a connecting tube 6, which is positioned facing the corresponding air inlet pipe 2, each of the air-conditioning ducts being formed by an air inlet pipe and an associated connecting tube.

The optical device 1 is distinctive, notably, in that it forms a means which is easily mounted on an air-conditioning duct to form the interconnection between the pipe and tubes of said duct, and in that it comprises an optical guide element 8 adapted to receive the light emitted by a light source 10 and to diffuse said light into the device to illuminate the air inlet pipe and the air outlet.

As can be seen in FIG. 4, the optical device 1 may comprise a support element 12 of the optical guide element 8. These two elements have a generally cylindrical shape with an annular cross section and a common axis, coinciding with the axis of the air inlet pipes and the connecting tubes. At an axial end 14, the optical device carries first fastening means 16 adapted to be fitted around the connecting tube 6 of the air-conditioning air outlet nozzle, while, at the opposite axial end 18, the optical device carries second fastening means 20 which are adapted to be fitted onto the downstream end of an air inlet pipe 2.

The optical guide element is fixed to the support element, being applied around the support element on the outer face of the latter. These two elements are axially offset from one another, so that one axial end of the support element is not covered by the optical guide element. This disengaged axial end is prolonged perpendicularly toward the outside of the support element by a collar 22 extending over the whole circular periphery of the device. The collar is adapted to carry an annular printed circuit board 24 on which at least one light-emitting diode is mounted. The collar extends perpendicularly to the axis of the device, so that the diode mounted thereon is adapted to diffuse light along an optical axis coinciding with the common axis of the air inlet pipe and the connecting tube of the air outlet nozzle. It should be noted that, in this arrangement, the printed circuit board is located outside the ventilation duct.

The support element also comprises a ridge 26 projecting radially over the whole periphery of the annular body 27 of the support element, onto which ridge the optical guide element is glued. The ridge provides an appropriate gluing surface and it elevates the optical guide element in such a way that an input face of this guide element is positioned facing the collar and the diode mounted thereon. The optical guide element is formed from polymethyl methacrylate (also known by the abbreviation PMMA), and the gluing of this element, using an epoxy adhesive for example, may require the cleaning of the support surface before the gluing operation. In this context, the ridge enables the surface to be treated to be finely formed before the gluing of the optical guide element.

The support element also carries the second fastening means which take the form of two lips adapted to grip the downstream end of the air inlet pipe. One lip is formed by the annular body of the support element and a second lip is formed by a fin 28 extending axially along said annular body.

Evidently, in the case described below relating to a variant where the optical guide element is not associated with a support element, the second fastening means may be formed by a second simple annular wall 29.

The optical guide element comprises a receiving area 30, formed by a first annular portion with a straight cross section, and a distribution area 32, formed by a conical annular portion positioned in the prolongation of the receiving area.

The receiving area comprises an outer face 34 and an inner face 36, which are parallel and which define a guide path between a free end face 38 and the distribution area 32. The receiving area has the function of propagating toward the distribution area the light rays which enter through the input face of the optical guide element, corresponding to the free end of the receiving area. It is prolonged, at its end opposite the input face, by the distribution area.

This distribution area also comprises an outer face 40 and an inner face 42, as well as an end face 44. The outer face is inclined relative to the outer face of the receiving area, in the direction of an approach toward the axis of the air-conditioning duct, that is to say in the direction of a reduction of the diameter of the distribution area as the distance from the receiving area increases. The inner face is also inclined relative to the inner face of the receiving area, with an inclination substantially equivalent to that of the outer face.

The distribution area is also prolonged axially, at the junction between the outer face and the end face, by a first wall of annular cross section 46, of the sleeve type, which forms the first fastening means, this sleeve having an inside diameter slightly greater than the diameter of the connecting tube of the air outlet nozzle, so that it can enable the optical device to be fixed to the connecting tube by fitting on it.

The distribution area has the function of deflecting the light rays from the receiving area toward an output face of the optical guide element, corresponding to the end face of the distribution area.

As described in greater detail in the description of the assembly and operation of the device, it is found that a plurality of functional faces can be identified for the guidance of the light rays by the optical guide element. An input face is located on the receiving area, while an output face is located on the distribution area. Similarly, this distribution area has a return face 48, formed by the outer face. The input face is substantially perpendicular to the axis of the air inlet pipe, to facilitate the entry of the light rays emitted from a light source in the optical guide element, and the return face directs the rays leaving the guide portion with a straight cross section so as to orient them toward the output face, since the latter is not in a plane parallel to the input face, but is directed toward the inside of the device, having an inclined plane relative to the axis of the air inlet pipe. By way of example, FIG. 3 shows the path of two rays between the input face and the output face.

The conical shape of the distribution area and the size of the outer and inner faces cause the end face of the distribution area, that is to say the output face of the optical device, to have an inclined annular shape whose mean diameter is smaller than that of the connecting tube of the air outlet nozzle.

Evidently, it is important, according to the invention, for the output face to be inclined relative to the common axis of the air inlet pipe and the connecting tube of the air outlet nozzle, so that the light emitted from the output of the optical guide at a given location on the output face is not guided directly toward the diametrically opposed part of the output face. It is important for the light rays emitted from the output of the guide to be directed obliquely so as to undergo total internal reflection on the connecting tube of the outlet nozzle.

In this context, the output face may have an arrangement other than that shown in FIG. 3, for example an arrangement according to a first variant as shown in FIG. 4, in which the output face is retracted because the mean diameter is greater than the inside diameter of the connecting tube of the air outlet nozzle, or an arrangement according to a second variant as shown in FIG. 5, in which the output face is oriented in the opposite direction, toward the upstream end of the air inlet pipe. The upstream and downstream parts of the air inlet pipe are identified on the basis of the direction of air flow, toward the outlet nozzle.

In the first variant, the output face is thus retracted and is not directly visible by the user. When the light source is switched on, the light rays emerge through the output face, and it may be helpful, in terms of appearance, if the user does not see a ring of light with a definite contour, but rather a more diffuse light filling the whole of the air outlet nozzle.

In the second variant, this indirect light effect is also desired, and the light rays are oriented toward a bend in the air inlet pipe, so that the total internal reflection after emergence from the optical guide takes place at this bend, and the rays are then guided toward the outlet nozzle. Thus the aim is to illuminate a surface that the user can see at the far end of the duct. The bend is also inclined so that the air inlet pipe and the connecting tube are aligned to facilitate the fitting of the optical device. As shown in FIG. 5, the optical guide assembly has been turned round, with the light source emitting in the opposite direction to the direction of emission of the light source in the main embodiment and in the first variant. The same function could be provided by retaining the arrangement of the first embodiments and orienting the total internal reflection surface and the output face in a different manner.

The output face of the optical guide element is advantageously striated so that the light rays adapted to pass out of the light guide element by refraction at this output face are scattered outside the light guide.

The light source is formed by a light-emitting diode positioned facing the input face of the optical element. Advantageously, the light source is formed by three diodes, colored red, green and blue, in a known RGB light-emitting diode arrangement. The switching and intensity of the light-emitting diode is controlled by a microcontroller mounted on the printed circuit board. In the aforementioned case of an RGB diode, the operating and intensity instructions are determined so that the light rays leaving the diode have the desired color.

The device further comprises an enclosure 52 comprising an axial wall 54 and a transverse wall 56 which is fitted around the connecting tube. Thus the enclosure forms a housing in which the light source and the optical guide element are protected.

A description will now be given of the fitting of the optical device in the air-conditioning assembly of a motor vehicle, and the operation of this assembly equipped with the device of the invention, which has the advantage of being able to be easily fitted and being immediately ready for use.

The device is initially fitted on the air outlet nozzle side of the instrument panel before the latter is attached to the structure of the vehicle. The optical device is mounted by fitting onto the upstream end of the connecting tube, using the first fastening area. A device can be installed for each of the air outlet nozzles, or for only some of them.

In a second stage, the instrument panel is then attached so as to align each of the nozzles with a corresponding air inlet pipe. The optical device is then mounted by fitting onto the air-conditioning ducts, using the second fastening means, and the microcontroller, which is located on the printed circuit board fixed to the device at the position of the collar of the support element, is simultaneously connected to the output connectors of the control module of the air-conditioning assembly.

When the user presses the air conditioning control button to request a given temperature, or to send an instruction for cold or hot air distribution, the air-conditioning assembly proceeds to deliver air at the correct temperature via the outlet nozzles. At the same time, provision is made to switch on the diode carried by the optical device according to the invention, to illuminate the nozzle through which the air is made to emerge. By way of example, a specific blue diode is switched on, or an RGB diode is switched on in such a way that it emits a blue light, so that the user receives visual information about the type of air being blown in by the air conditioning, or about the temperature in the passenger compartment. As may have been specified previously, reference may be made to the patent application filed by the applicant on the same date as the present application, in order to discover the details of the operation of the air-conditioning assembly with which an optical device according to the present invention has been associated. It will be evident from that application, notably, that the microcontroller associated with the diode is adapted to receive information from the control module of the air-conditioning assembly for the purpose of controlling the switching on of the light source, and, in the case of an RGB diode, controlling the choice of color of the light emitted by modulation of the three main color sources, these instructions for switching on the light source being based on data held centrally in the control module.

The diode emits light which penetrates by refraction into the optical guide element whose flat input face is positioned facing the diode. The refracted light is propagated in the optical guide element, initially in the receiving area and then in the distribution area.

The light is directed toward the outer face of this distribution area, which forms a return surface for the total internal reflection of the rays heading toward the output face. The rays are then refracted so as to be propagated inside the optical device into the connecting tube or the air inlet pipe. The inclination of the output face enables the rays to travel toward the air outlet nozzle at a given angle relative to the axis of this outlet nozzle, so that the rays travel by successive reflections inside the connecting tube toward the air outlet nozzle. The coating of the output face, which may be striated, also facilitates this movement of the rays by successive reflections by scattering the light beam.

The above description clearly explains how the invention can be used to achieve the proposed aims and, notably, to provide a device which is easily integrated into an air-conditioning duct, by forming the interconnection between the air inlet pipes and the air outlet nozzles, while also allowing the provision of a function of illuminating the inside of this air-conditioning duct. The integration of this function is particularly simple in terms of manufacturing and installation. The device according to the invention enables the air outlet nozzles to be illuminated internally, so that the occupant of the vehicle can be provided with additional information on the state of the air conditioning. This illumination is furthermore produced by inserting the device according to the invention by fitting it between tubes and pipes which are already present. Thus no special machining has to be carried out on the instrument panel to house the lighting means. It will also be evident that, should the motor vehicle manufacturer not wish to install the optical device, he will have the option of replacing it by fitting an interconnecting device of the sleeve type, without an integrated optical guide, between the air inlet pipe and the connecting tube of the air outlet nozzle.

Additionally, the design of the optical device as described above enables a highly modular structure to be provided, since there is a plurality of possible lighting orientations, according to whether the device is fitted in one or the other direction, and according to whether or not the size and shape of the optical guide element are modified, while retaining the shape and size of the support element providing the interconnection.

The location of the printed circuit board, and the microcontroller mounted thereon, on the periphery of the air-conditioning duct facilitates the connection of the microcontroller to the control module of the air-conditioning assembly. The light assembly according to the invention combines the advantage of this external positioning of the microcontroller with that of the internal positioning of the output face of the optical guide element for the illumination of the interior of the air-conditioning ducts.

The integration of the printed circuit board into the support element facilitates the installer's connection of the electronic components required for the transmission of the control instructions toward the device, for the purpose of switching on different types of lighting according to the detected conditions relating to the air conditioning of the passenger compartment.

Evidently, various modifications may be made by persons skilled in the art to the structures of the optical device, which have been described by way of non-limiting examples, provided that the optical device has the functional optical parts as specified above, and provided that the arrangement of the device in the air-conditioning assembly is such that the air-conditioning ducts can be internally illuminated while the device forms part of the interconnection of the various tubes and pipes forming these air-conditioning ducts.

In different variants which are not illustrated, provision may be made, for example, to omit the enclosure fitted on top of the optical device, to produce the fastening means in different ways, or to make the support element and the optical guide element in one piece, these steps being taken separately or in combination.

In the variant in which the enclosure is not provided, care must be taken to incline the outer face of the distribution area so that it forms a total internal reflection surface for all the rays arriving from the receiving area, and so that none of the light rays is propagated outside the air-conditioning duct associated with the optical device. Evidently, therefore, the enclosure has a supplementary function, since, in addition to the protection provided for the diode and the optical guide element, it also forms a casing to prevent the random diffusion of light rays outside the device, for example at the point where the light rays pass between the diode and the input face.

In the variant in which the fastening means are different, provision could be made to form the first and second fastening means as a simple annular wall having a diameter slightly greater or smaller than that of the tube or pipe with which the device interacts when fitted thereon. This is useful, notably, in the context of the variant in which the optical guide element is not associated with a support element. In this case, the whole of the optical device is formed from a transparent material of the PMMA type, and the fastening means are also made of this material. This variant has the advantage of reducing the number of constituent parts of the optical device, while also simplifying the shapes of the parts as much as possible, PMMA being a material which has very good optical properties but is relatively fragile.

1. A light assembly comprising an optical device adapted to be mounted on the path of an air-conditioning duct of a motor vehicle, said optical device comprising a first fastening means and a second fastening means at one and the other of its axial ends respectively, for fastening said optical device to an air inlet pipe and to a connecting tube fixed to an air outlet nozzle, said optical device further comprising an optical guide element, said optical guide element being adapted to receive through an input face the light rays emitted by at least one light source, said at least one light source being positioned outside said air-conditioning duct, and to diffuse said light rays through an output face directed toward the inside of said air-conditioning duct.

2. The light assembly as claimed in claim 1, wherein said input face is housed outside said air-conditioning duct defined by said air inlet pipe and said connecting tube, being notably substantially perpendicular to an axis of revolution.

3. The light assembly as claimed in claim 1, wherein said output face is inclined relative to a plane of said input face and is directed toward the inside of said air-conditioning duct.

4. The light assembly as claimed in claim 1, wherein said optical device is fitted in such a way that said first fastening means interact with said connecting tube, while said second fastening means interact with said air inlet pipe.

5. The light assembly as claimed in claim 1, wherein said optical device is fitted in such a way that said first fastening means interact with said air inlet pipe, while said second fastening means interact with said connecting tube.

6. The light assembly as claimed in claim 1, wherein said optical guide element is an optical guide element of annular shape, having an axis of revolution coinciding with that of said air-conditioning duct at a mounting location of said optical device.

7. The light assembly as claimed in claim 1, wherein said optical guide element carries said first fastening means.

8. The light assembly as claimed in claim 6, wherein said first fastening means take the form of a first simple annular wall adapted to be mounted by fitting around an upstream end of said connecting tube said air outlet nozzle or around a downstream end of said air inlet pipe, said first simple annular wall being made in one piece with said optical guide element and prolonging the latter axially at its free end.

9. The light assembly as claimed claim 6, wherein said optical element carries said second fastening means.

10. The light assembly as claimed in claim 9, wherein said second fastening means take the form of a second simple annular wall adapted so that an upstream end of said connecting tube of said air outlet nozzle or a downstream end of said air inlet pipe is mounted by fitting around said second wall, said second simple annular wall being made in one piece with said optical guide element and prolonging the latter axially at the level of said output face.

11. The light assembly as claimed in claim 6, wherein said light assembly comprises a support element of said optical guide element, said support element being of annular shape and having an axis of revolution identical to that of said optical guide element, and in that said support element carries said second fastening means.

12. The light assembly as claimed in claim 11, wherein said second fastening means take the form of two annular lips adapted to grip a downstream end of said air inlet pipe or an upstream end of said connecting tube of said air outlet nozzle, one of said two annular lips being formed by an annular body of a support element, the other of said two annular lips being formed by a fin made in one piece with said annular body and extending along the latter.

13. The light assembly as claimed in claim 6, wherein said light assembly comprises a support element of said optical guide element, said support element being of annular shape and having an axis of revolution identical to that of said optical guide element.

14. The light assembly as claimed in claim 13, wherein at least one light source is formed by a light-emitting diode mounted on a printed circuit board which is of substantially annular shape and is fixed to an annular collar made in one piece with said support element, so as to be positioned facing said input face of said optical guide element.

15. The light assembly as claimed in either of claim 13, wherein said support element and said optical guide element are formed by two separate pieces, said optical guide element being attached around said support element by gluing.

16. The light assembly as claimed in claim 13, wherein said support element has a radially projecting ridge around the whole periphery of an annular wall of said support element, said radially projecting ridge being adapted to receive means for the gluing of said optical guide element.

17. A motor vehicle, in which an air-conditioning assembly comprises a control module adapted to generate instructions for controlling the air distribution in air-conditioning ducts which are distributed in the structure of the vehicle, said air-conditioning ducts having inlet pipes for guiding this air toward nozzles for the outlet of the air toward the passenger compartment, wherein it comprises at least one light assembly as claimed in claim 1, in which an optical device is fitted in the prolongation of, on the one hand, a connecting tube fixed to an air outlet nozzle, and, on the other hand, an air inlet pipe, to provide an interconnection thereof and allow the continuous passage of air toward said air outlet nozzles, said optical device also being adapted to illuminate the inside of corresponding said air-conditioning duct.

18. The light assembly as claimed in claim 7, wherein said light assembly comprises a support element of said optical guide element, said support element being of annular shape and having an axis of revolution identical to that of said optical guide element, and in that said support element carries said second fastening means.

19. The light assembly as claimed in claim 2, wherein said output face is inclined relative to a plane of said input face and is directed toward the inside of said air-conditioning duct.

20. A light assembly comprising an optical device adapted to be mounted on the path of an air-conditioning duct of a motor vehicle, said optical device comprising a first fastener and a second fastener at one and the other of its axial ends respectively, for fastening said optical device to an air inlet pipe and to a connecting tube fixed to an air outlet nozzle, said optical device further comprising an optical guide element, said optical guide element being adapted to receive through an input face the light rays emitted by at least one light source, notably a light source positioned outside said air-conditioning duct, and to diffuse said light rays through an output face directed toward the inside of said air-conditioning duct.
